(19) United States
(12) Patent Application Publication
(10) Pub. No.: US 2006/0138041 A1
(43) Pub. Date: Jun. 29, 2006

(54) Filter for liquids, especially transmission oil in automatic transmissions of motor vehicles

(76) Inventor: Antonio Chiga, Dammartin en Goele (FR)

Correspondence Address: BRINKS HOFER GILSON & LIONE, P.O. BOX 10395, CHICAGO, IL, 60610, US

(21) Appl. No.: 11/319,313

(22) Filed: Dec. 28, 2005

Related U.S. Application Data
(63) Continuation of application No. PCT/EP04/07038, filed on Jun. 29, 2004.

(30) Foreign Application Priority Data
Jul. 25, 2003 (DE) DE 203 11 465.5
Jul. 1, 2003 (DE) DE 203 10 102.2

(51) Int. Cl. B01D 35/00

(52) U.S. Cl. 210/455

(57) ABSTRACT

A filter assembly for fluids, especially for transmission oil in an automatic transmission of a motor vehicle having a housing comprising a top part and a bottom part connected thereto. The housing includes an inlet and an outlet, wherein disposed between the top part and the bottom part there is a filter medium separating the inlet from the outlet. Within an area of the housing there are provided at least two supporting bodies, separated from one another in a spaced-apart relationship, wherein each supporting body is also maintained in a spaced-apart relationship relative to the top part and the bottom part. The filter medium is guided around the supporting bodies in one or more S-shaped loops such that the filter medium is effective in at least three layers above each other within a portion of the filter assembly.

The present application is a continuation of International Application PCT/EP2004/007038, with an international filing date on Jun. 29, 2004, which claims the benefit of priority to German Utility Model Application DE 203 11 465.5, filed on Jul. 25, 2003, and German Utility Model Application DE 203 10 102.2, filed Jul. 1, 2003, and all of the foregoing identified applications are herein incorporated by reference.

### BACKGROUND

The present invention relates to a filter for fluids, especially for transmission oil in an automatic transmission of a motor vehicle having a housing consisting of a top part and a bottom part connected thereto. The housing includes an inlet and an outlet, wherein disposed between the top part and the bottom part there is a filter medium separating the inlet from the outlet.

Such filters are generally known in the art. The filter consists of a bottom part made of plastic and a cover made of metal. The filter medium positioned therein separates the inlet from the outlet of the housing of such filters and the edge of the filter is clamped between the top part and the bottom part. In many cases the problem is that the space into which such filters are disposed is extremely limited. This space consideration is sometimes at odds simultaneously with large filter efficiency.

### BRIEF SUMMARY

The present invention is directed to the improvement of a filter of the above kind in such a way that the filter medium area is as large as possible.

It is an objective to provide a filter assembly that occupies a small space while substantially improving performance. It is another objective that as far as the available space or the shape of the housing allows, the number of the supporting bodies can be increased such that the additional layers of the filter medium formed substantially increase the effective filter area.

Accordingly, an aspect of the present invention is to provide at least two supporting bodies, one above the other in a spaced-apart relationship, wherein each supporting body is also maintained in a spaced-apart relationship relative to the top part and the bottom part. The filter medium is guided around the supporting bodies in S-shaped loops such that the filter medium is effective in at least three layers above each other.

In one embodiment, the supporting bodies are positioned substantially parallel to each other to achieve an appropriate orientation of the layers of the filter medium and thereby achieve advantageous flow conditions and filter efficiency.

Preferably, the supporting bodies are formed in the shape of frames which has the advantage that the through-put of the filter is thereby not impeded.

In another embodiment, the supporting bodies include wave-shaped projections on their surfaces carrying the filter medium. By this aspect, the filter medium is supported over an area advantageously at several discrete points to expose greater filter medium surface area.

The support bodies can be attached to the housing by any attachment means including, but not limited to, insertion, clasping, or clamping. In one embodiment, the supporting bodies are connected with the bottom part and the top part by means of supporting arms. The manufacture of such a filter is simplified because no complicated molds have to be used.

An alternative embodiment is provided wherein the supporting bodies are connected with each other directly instead of being connected to the housing. An especially simple construction is created when the supporting bodies are carried by the filter medium, such as when the support bodies are a plastic, such as nylon, molded (such as plastic injection insert molding) onto an appropriate filter medium, which may also be nylon or another suitable medium for this application.

In a further embodiment, the supporting bodies are connected with each other by pins passing through the filter medium and received in sockets of the adjacent supporting body. This forms an especially simple construction, wherein the connection of the supporting bodies with each other can be done by pins or clips, ultrasonic welding, adhesives or similar means.

Due to the fact that in one or more of the embodiments the pins or the like may pass through the filter medium, it is preferred that the interface between the supporting bodies with the filter medium is sealed by seals, such as a seal integrated into the filter medium. Such a seal may be molded onto the filter medium using plastic constituents suitable for this application and molding that those of skill in the art may readily ascertain.

In a further alternative embodiment, the supporting bodies are connected with each other and are also connected to the bottom part of the housing in a sealed manner, such as denoted above. The advantage of this is that during the manufacture of the filter assembly, the position and guiding of the filter medium is unequivocally defined such that the probability of incorrect assembly of the device, resulting from the wrong supporting body being assembled in the wrong place, is dramatically decreased, if not eliminated.

In particular, the embodiments can be further improved by manufacturing the supporting bodies from a plastic material, wherein the supporting bodies are formed of the same plastic material as the bottom part and the top part. One example of a plastic material includes nylon-66 (or PA 66) having a glass-fiber content of 30%.

In yet another alternative embodiment, the supporting bodies are connected to the top part and the bottom part, respectively, by ultrasonic welding.

Moreover, in another aspect, the filter medium is clamped and fixed in the region of the inner margins of flanges at the exterior edge of the top part and the bottom part. Further, the top part is connected to the bottom part, wherein the flanges of the top and bottom parts are welded together.

Advantages of the present invention will become more apparent to those skilled in the art from the following description of preferred embodiments, which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 a top view of one embodiment of a filter assembly;

FIG. 2 is a cross-sectional view along the line A-A of FIG. 1; and

FIG. 3 is a magnified cross-section of another embodiment of a filter assembly.

### DETAILED DESCRIPTION OF THE DRAWINGS AND THE PRESENTLY PREFERRED EMBODIMENTS

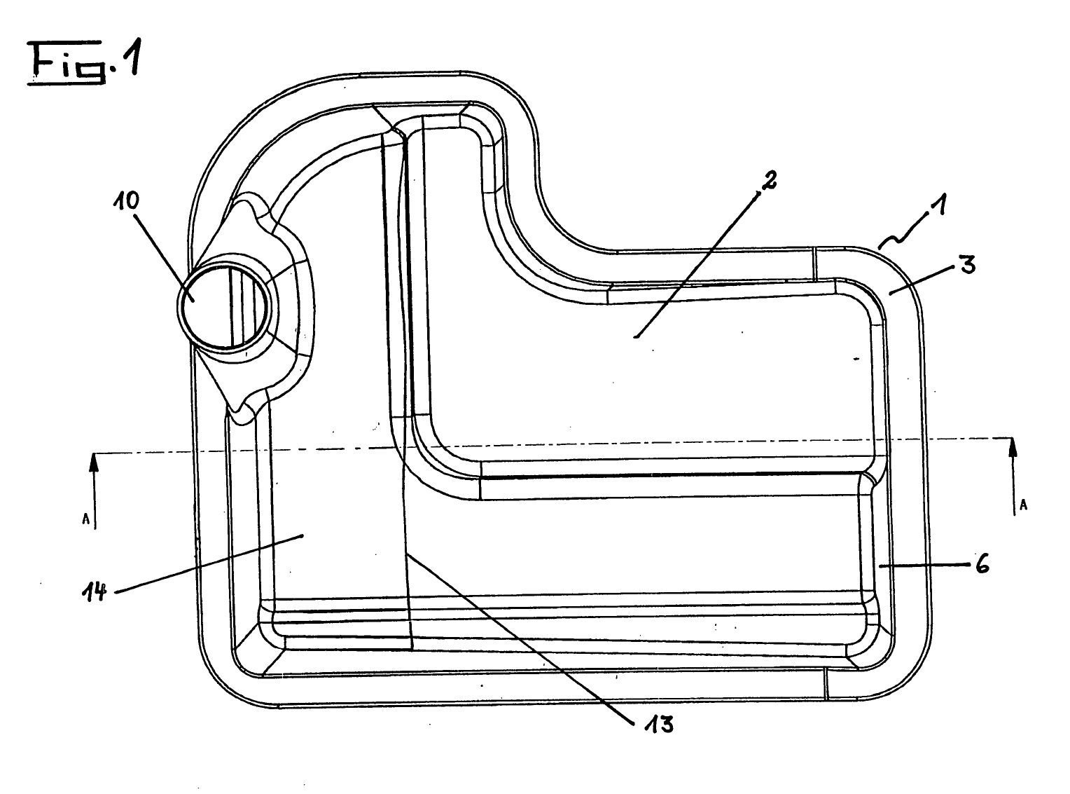

Referring to FIGS. 1-3, the filter 1 is intended for transmission oil of automatic transmissions for motor vehicles, wherein the filter 1 includes a housing 6 comprising a top part 2 and a bottom part 4.

The housing 6 further includes an inlet 8 and an outlet 10. A filter medium 12 separating the inlet 8 from the outlet 10 is positioned within the housing 6, wherein the filter medium 12 is clamped and fixed between a circumferential flange 3 at the top part 2 and a circumferential flange 5 at the bottom part 4 in the region of the inner margins thereof. During manufacture, the flanges 3 and 5 are molded or welded together to connect the top part 2 with the bottom part 4, and preferably ultrasonically welded.

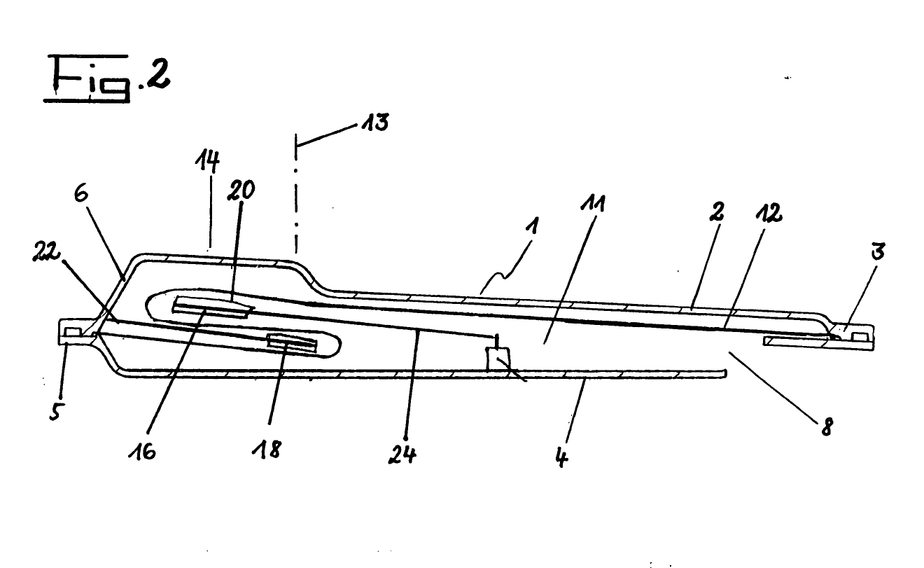

To drastically enlarge the available filter area of the filter medium 12 within a given volume of the interior 11 of the housing 6, at least in the area 14 separated by the line 13 in FIGS. 1-2, there are provided at least two supporting bodies 16, 18 positioned in a spaced-apart manner relative to each other. These supporting bodies 16, 18 are also maintained in a spaced-apart relationship relative to the top part 2 and the bottom part 4. As shown in FIG. 2, the filter medium 12 is guided around the supporting bodies 16, 18 in an S-shaped pattern such that in the area 14 the filter medium 12 is effective in three stacked layers which means that in the area 14 the available filter area is tripled. If one skilled in the art wants to increase the filter area again, further supporting bodies 16, 18 can be provided around which the filter medium is guided in further loops.

The supporting bodies 16, 18 are formed as frames, the shape of which roughly corresponds to the area 14 and are include wave-shaped projections 20 on the sides supporting the filter medium 12 such that the filtration hardly is impeded by the supporting bodies 16 and 18.

As illustrated in FIG. 2, the supporting body 16 is attached to at least one supporting arm 22 that is fixed to the top part 2, and the supporting body 18 is attached to at least one supporting arm 24 that is fixed to the bottom part 4.

Preferably, the top part 2, bottom part 4, and the supporting bodies 16, 18 are formed of plastic, wherein these parts are all manufactured from the same material. A suitable plastic material is nylon-66 (or PA 66) having a glass-fiber content of 30%.

To save large costs for the molds for the top and bottom parts 2, 4, the supporting bodies 16, 18 and their supporting arms 22, 24 are connected to the top part 2 and the bottom part 4, respectively, by ultrasonic welding.

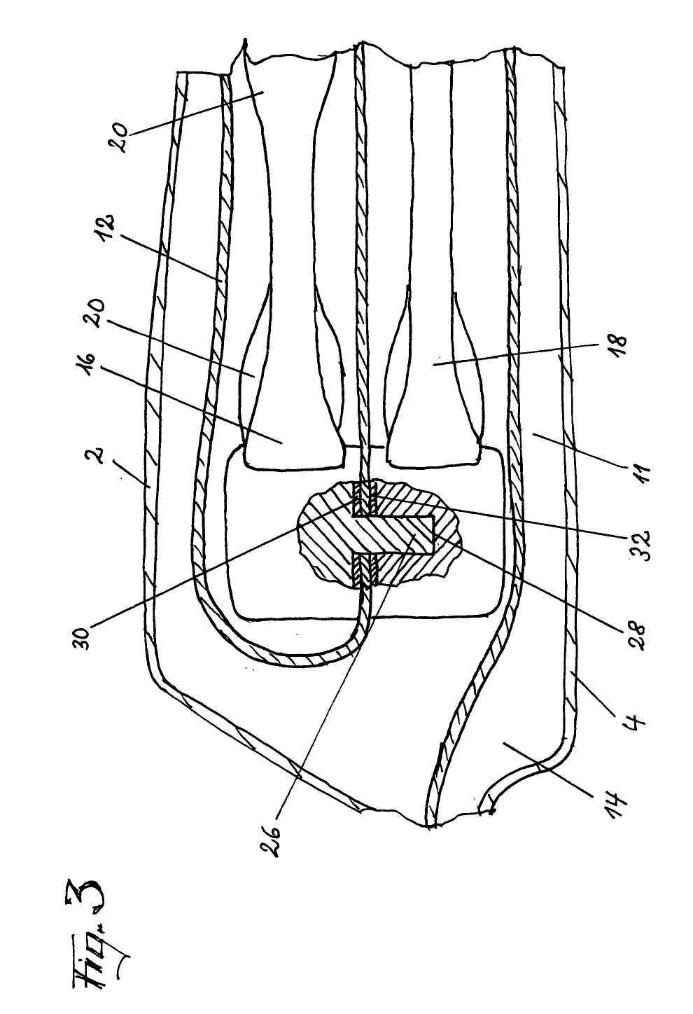

Referring to FIG. 3, a cross-section of an alternative embodiment of a filter 1 is shown, wherein the supporting bodies 16, 18 are not connected to the bottom part 4 or the top part 2, respectively, by supporting arms. Instead, the supporting bodies 16, 18 are connected to each other and are not attached to the housing 6.

In the alternative embodiment shown in FIG. 3, the supporting bodies 16, 18 are connected by means of a pin 26 projecting from the supporting body 16, and the pin 26 is received in a socket 28 in the supporting body 18, wherein the pin 26 passes through the filter medium 12.

To avoid a leak at the point at which the pin 26 passes through the filter medium 12 in the filter medium 12 at the connection of the supporting bodies 16, 18 formed by the pin 26 is received in the socket 28, there are seals 30, 32 which provide a seal for this connection.

The embodiment shown in FIG. 3 can be further modified such that the supporting bodies 16, 18 are connected in the way shown and also includes a connection to the bottom part 4 of the housing 6 which can be made by ultrasonic welding, adhesives, clasping or similar connecting means. This connection may also be sealed.

To prevent the filter medium 12 from clinging to the walls of the housing 6 during the filtration, which may be detrimental to flow and filtration efficiency, the interior surfaces of the top part 2 and the bottom part 4 may be provided with projecting segments or button shaped supporting feet positioned in rows (not shown in the drawings), as described and shown in detail in German Patent DE-GM 201 09 917.9 or U.S. Pat. No. 6,575,309 B1, the disclosures of which are incorporated by reference herein.

All features and advantages of the present invention, including construction details and relative positions within the space provided, can be learned from the specification, the claims and the drawings. While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A filter assembly for fluids, especially for transmission oil in automatic transmissions of motor vehicles, having a housing with an inlet and an outlet, the housing including a top part and a bottom part connected therewith, wherein between the top part and the bottom part there is positioned a filter medium separating the inlet from the outlet, the filter assembly comprising: at least two supporting bodies positioned within an area of the housing separated in a spaced-apart relationship and the at least two support bodies are maintained in a spaced-apart relationship relative to the top part and the bottom part, and that the filter medium is guided around the supporting bodies, thereby forming one or more S-shaped loops within the area of the housing such that the filter medium is effective in at least three stacked layers within a portion of the filter assembly.

2. The filter assembly of claim 1, wherein the supporting bodies are arranged substantially parallel to each other.

3. The filter assembly of claim 2, wherein the supporting bodies have the shape of a frame.

4. The filter assembly of claim 3, wherein the supporting bodies have wave-shaped projections on the surfaces of the supporting bodies that attach to the filter medium.

5. The filter assembly of claim 4, wherein each of the supporting bodies is connected with either the bottom part or the top part by way of a supporting arm.

6. The filter assembly of claim 5, wherein the supporting bodies are formed of a plastic material.

7. The filter assembly of claim 6, wherein the top part and the bottom part are formed of the same plastic material as the supporting bodies.

8. The filter assembly of claim 7, wherein the plastic material is nylon-66 having a glass-fiber content of 30%.

9. The filter assembly of claim 8, wherein the supporting bodies are connected to the top part or the bottom part by way of ultrasonic welding.

10. The filter assembly of claim 9, wherein the top part and the bottom part each includes a flange, and the filter medium is clamped and fixed within a region of inner margins of the flanges at an exterior edge of the top part and bottom part.

11. The filter assembly of claim 10, wherein the flanges of the top part and the bottom part are welded together.

12. The filter assembly of claim 1, wherein the supporting bodies are connected to each other.

13. The filter assembly of claim 12, wherein the supporting bodies are connected each other by a pin extending from each supporting body which passes through the filter medium and each pin being received in a socket formed in the adjacent supporting body.

14. The filter assembly of claim 13, wherein the connections between the supporting bodies are sealed by a seal.

15. The filter assembly of claim 14, wherein the supporting bodies are connected to each other as well as the bottom part of the housing in a sealed manner.

16. The filter assembly of claim 15, wherein the supporting bodies are formed of a plastic material, and the top part and the bottom part are formed of the same plastic material as the supporting bodies.

17. The filter assembly of claim 16, wherein the plastic material is nylon-66 having a glass-fiber content of 30%.

18. The filter assembly of claim 17, wherein the supporting bodies are connected to the top part or the bottom part by way of ultrasonic welding.

19. The filter assembly of claim 18, wherein the top part and the bottom part each includes a flange, and the filter medium is clamped and fixed within a region of inner margins of the flanges at an exterior edge of the top part and bottom part.

20. The filter assembly of claim 19, wherein the flanges of the top part and the bottom part are welded together.

21. A filter assembly for fluids, especially for transmission oil in automatic transmissions of motor vehicles, having a housing with an inlet and an outlet, a filter medium disposed between the inlet and outlet, the filter medium located between a top part and a bottom part, wherein the top part and the bottom part are connected therewith, the filter assembly comprising:
at least two supporting bodies oriented in a spaced-apart manner relative to the top and bottom parts as well as the other of the at least two supporting bodies; and
at least one S-shaped loop within the housing, wherein the at least one S-shaped loop is formed by guiding the filter medium around the supporting bodies.

22. The filter assembly of claim 21, wherein the filter medium forming at least one S-shaped loop is effective in at least three stacked layers within the housing.

23. The filter assembly of claim 21, wherein the supporting bodies have the shape of a frame.

24. The filter assembly of claim 21, wherein the supporting bodies have wave-shaped projections on surfaces of the supporting bodies that attach to the filter medium.

25. The filter assembly of claim 21, wherein the supporting bodies are arranged substantially parallel to each other.

26. The filter assembly of claim 25, wherein the supporting bodies are formed of a plastic material.

27. The filter assembly of claim 26, wherein the top part and the bottom part are formed of the same plastic material as the supporting bodies.

28. The filter assembly of claim 27, wherein the plastic material is nylon-66 having a glass-fiber content of 30%.

29. The filter assembly of claim 26, wherein the supporting bodies are connected to the top part or the bottom part by way of ultrasonic welding.

30. The filter assembly of claim 29, wherein the top part and the bottom part each includes a flange, and the filter medium is clamped and fixed within a region of inner margins of the flanges at an exterior edge of the top part and bottom part.

31. The filter assembly of claim 30, wherein the flanges of the top part and the bottom part are welded together.

32. The filter assembly of claim 25, wherein each of the supporting bodies is connected with either the bottom part or the top part by way of a supporting arm.

33. The filter assembly of claim 32, wherein the supporting bodies are formed of a plastic material.

34. The filter assembly of claim 33, wherein the top part and the bottom part are formed of the same plastic material as the supporting bodies.

35. The filter assembly of claim 34, wherein the plastic material is nylon-66 having a glass-fiber content of 30%.

36. The filter assembly of claim 33, wherein the supporting bodies are connected to the top part or the bottom part by way of ultrasonic welding.

37. The filter assembly of claim 36, wherein the top part and the bottom part each includes a flange, and the filter medium is clamped and fixed within a region of inner margins of the flanges at an exterior edge of the top part and bottom part.

38. The filter assembly of claim 37, wherein the flanges of the top part and the bottom part are welded together.

39. The filter assembly of claim 21, wherein each of the supporting bodies is connected with either the bottom part or the top part by way of a supporting arm.

40. The filter assembly of claim 39, wherein the supporting bodies are formed of a plastic material.

41. The filter assembly of claim 40, wherein the top part and the bottom part are formed of the same plastic material as the supporting bodies.

42. The filter assembly of claim 41, wherein the plastic material is nylon-66 having a glass-fiber content of 30%.

43. The filter assembly of claim 40, wherein the supporting bodies are connected to the top part or the bottom part by way of ultrasonic welding.

44. The filter assembly of claim 43, wherein the top part and the bottom part each includes a flange, and the filter medium is clamped and fixed within a region of inner margins of the flanges at an exterior edge of the top part and bottom part.

45. The filter assembly of claim 44, wherein the flanges of the top part and the bottom part are welded together.

46. The filter assembly of claim 21, wherein the supporting bodies are connected to each other.

47. The filter assembly of claim 46, wherein the supporting bodies are connected each other by a pin extending from each supporting body which passes through the filter medium and each pin being received in a socket formed in the adjacent supporting body.

48. The filter assembly of claim 47, wherein the connections between the supporting bodies are sealed by a seal.

49. The filter assembly of claim 48, wherein the supporting bodies are connected to each other as well as the bottom part of the housing in a sealed manner.

50. The filter assembly of claim 49, wherein the supporting bodies are formed of a plastic material.

51. The filter assembly of claim 50, wherein the top part and the bottom part are formed of the same plastic material as the supporting bodies.

52. The filter assembly of claim 51, wherein the plastic material is nylon-66 having a glass-fiber content of 30%.
